(19) United States
(12) Patent Application Publication
(10) Pub. No.: US 2014/0244197 A1
(43) Pub. Date: Aug. 28, 2014

(54) Determining Most Relevant Data Measurement from Among Competing Data Points

(71) Applicant: SAP AG, Walldorf (DE)

(72) Inventor: Scott Boudreau, Palo Alto, CA (US)

(73) Assignee: SAP AG, Walldorf (DE)

(21) Appl. No.: 13/893,128

(22) Filed: May 13, 2013

Related U.S. Application Data
(60) Provisional application No. 61/770,596, filed on Feb. 28, 2013.

(51) Int. Cl. G01D 18/00

(52) U.S. Cl. CPC G01D 18/00
USPC 702/104

(57) ABSTRACT

Disclosed herein are techniques for determining a most relevant data measurement from among competing data points. Particular embodiments call for an evaluation engine to receive as input from an underlying database, a plurality of competing data points together with meta-data reflecting a provenance of those data points. The evaluation engine is configured to apply a precedence rule set to the input, and produce an output comprising a most relevant data measurement. Via application of the precedence rule set, the evaluation engine may consider expected reliability of the source of the data measurement. The precedence rule set may also reflect other factors, such as a number of alternative sources for the measurement, a freshness of the measurement, and/or a possibility of combining (e.g. averaging) a plurality of otherwise equally situated measurements. An example evaluates the statistics of pro football prospects (e.g. foot speed) available from different sources (e.g. scouting reports).

### CROSS-REFERENCE TO RELATED APPLICATION

The instant nonprovisional patent application claims priority to U.S. Provisional Patent Application No. 61/770,596 filed Feb. 28, 2013 and incorporated by reference in its entirety herein for all purposes.

### BACKGROUND

Embodiments of the present invention relate to data handling, and in particular, to determination of a most relevant data measurement from competing data points.

Unless otherwise indicated herein, the approaches described in this section are not prior art to the claims in this application and are not admitted to be prior art by inclusion in this section.

When multiple measurements are taken for given quantity, variance may occur. This variance can be attributable to one or more factors such as observer bias, changes in the object being measured, environmentally-driven changes, or differences in interpretation.

Often, however, showing all of the measured results to a user is not desirable for efficient decision-making. Instead, it may be preferred to display a single “best” result.

A simple example of this concept can be illustrated in connection with purchasing a car. In that context, it may be preferred to choose a car based its mileage efficiency by relying upon a single “best” number, rather than by considering the result of every mileage test that could be performed.

The automatic application of simple rules (e.g. taking an average, or selecting the most recent data) may not be useful in choosing a best figure from such a pool of candidate data points. For example, in the car buying example, highway and city driving mileage values cannot simply be averaged in order to obtain a best result. Rather, the desired figure is the one that is relevant to the user and the purpose for which the information is to be used.

Accordingly, the present disclosure addresses these and other issues with methods and apparatuses configured to determine a most relevant data measurement from amongst competing data points.

### SUMMARY

Disclosed herein are techniques for determining a most relevant data measurement from among competing data points. Particular embodiments call for an evaluation engine to receive as input from an underlying database, a plurality of competing data points together with meta-data reflecting a provenance of those data points. The evaluation engine is configured to apply a precedence rule set to the input, and produce an output comprising a most relevant data measurement. Via application of the precedence rule set, the evaluation engine may consider expected reliability of the source of the data measurement. The precedence rule set may also reflect other factors, such as a number of alternative sources for the measurement, a freshness of the measurement, and/or a possibility of combining (e.g. averaging) a plurality of otherwise equally situated measurements. An example evaluates the statistics of pro football prospects (e.g. foot speed) available from different sources (e.g. scouting reports).

An embodiment of a computer-implemented method comprises providing an evaluation engine in communication with a database comprising a first data measurement, a first meta-data indicating a first source of the first data measurement, a second data measurement, and a second meta-data indicating a second source of the second data measurement. The evaluation engine is caused to calculate from the first meta-data, a first precedence value for the first data measurement. The evaluation engine is caused to calculate from the second meta-data, a second precedence value for the second data measurement. And, the evaluation engine is caused to reference a precedence rule set to determine a relevance of the first data measurement over the second data measurement.

An embodiment of a non-transitory computer readable storage medium embodies a computer program for performing a method comprising providing an evaluation engine in communication with a database comprising a first data measurement, a first meta-data indicating a first source of the first data measurement, a second data measurement, and a second meta-data indicating a second source of the second data measurement. The method also comprises causing the evaluation engine to calculate from the first meta-data, a first precedence value for the first data measurement. The method further comprises causing the evaluation engine to calculate from the second met-data, a second precedence value for the second data measurement. The evaluation engine is caused to reference a precedence rule set to determine a relevance of the first data measurement over the second data measurement.

An embodiment of a computer system comprises one or more processors and a software program executable on said computer system and configured to provide an evaluation engine in communication with a database comprising a first data measurement, a first meta-data indicating a first source of the first data measurement, a second data measurement, and a second meta-data indicating a second source of the second data measurement. The software program is further configured to cause the evaluation engine to calculate from the first meta-data, a first precedence value for the first data measurement. The software program is also configured to cause the evaluation engine to calculate from the second meta-data, a second precedence value for the second data measurement. The software program is configured to cause the evaluation engine to reference a precedence rule set to determine a relevance of the first data measurement over the second data measurement.

According to certain embodiments the first precedence value is different from the second precedence value, and the first precedence value indicates a provenance of the first source is greater than a provenance of the second source.

In some embodiments the first precedence value is the same as the second precedence value, and the precedence rule set relies upon a secondary criterion to determine the relevance of the first data measurement over the second data measurement.

In various embodiments the secondary criterion comprises a relative magnitude of the first data measurement versus the second data measurement.

In particular embodiments the secondary criterion comprises a freshness of the first data measurement versus the second data measurement.

Some embodiments further comprise causing the evaluation engine to display the first data measurement to a user.

The following detailed description and accompanying drawings provide a better understanding of the nature and advantages of particular embodiments.

### BRIEF DESCRIPTION OF THE DRAWINGS

FIG. 1 shows a simplified view of a system according to an embodiment.

FIG. 2 shows a simplified diagram illustrating a process flow according to an embodiment.

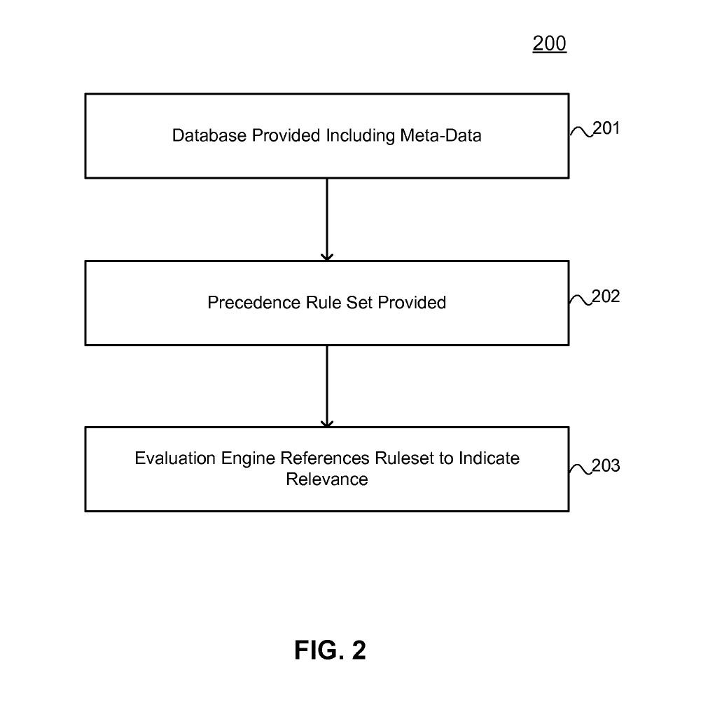

FIG. 3 illustrates hardware of a special purpose computing machine configured to determine of a most relevant data measurement according to an embodiment.

FIG. 4 illustrates an example of a computer system.

### DETAILED DESCRIPTION

Described herein are techniques for determining most relevant data from a pool of competing data points. The apparatuses, methods, and techniques described below may be implemented as a computer program (software) executing on one or more computers. The computer program may further be stored on a computer readable medium. The computer readable medium may include instructions for performing the processes described below.

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

Embodiments implement a “precedence” rules approach allowing each data element to be aligned with its intended purpose. In simplest terms, the precedence rules define which data point “wins” vs. another data point, based on one or more factors.

The precedence rules may take into account a provenance of the various data measurements. That is, meta-data stored with the data measurement in an underlying database, may indicate a source of the data. The structure of the precedence rules may in turn reflect that provenance, affording a priority to data originating from a source that is known to be more reliable or trustworthy than that of the other data candidates in the pool.

For example, by operation of precedence rules, a data point from a more trusted observer may be shown, rather than a competing data point from a less trusted observer's measurement. However, if only the less trusted observer's measurement is available, then the precedence rules could dictate that data point being used.

If two equally trusted observers' measurements are available, the precedence rules may call for the less-trusted data to be ignored. The two trusted values might be compared based on time, with, for example, the most recent being used. Alternatively, the two trusted values could be averaged.

The precedence rules could instruct that if a third observer, more trusted than any other, were to add a data point, then that data point would become the one to be displayed.

According to embodiments, these precedence rules may be configurable in the software, and different rules can be applied to each data element.

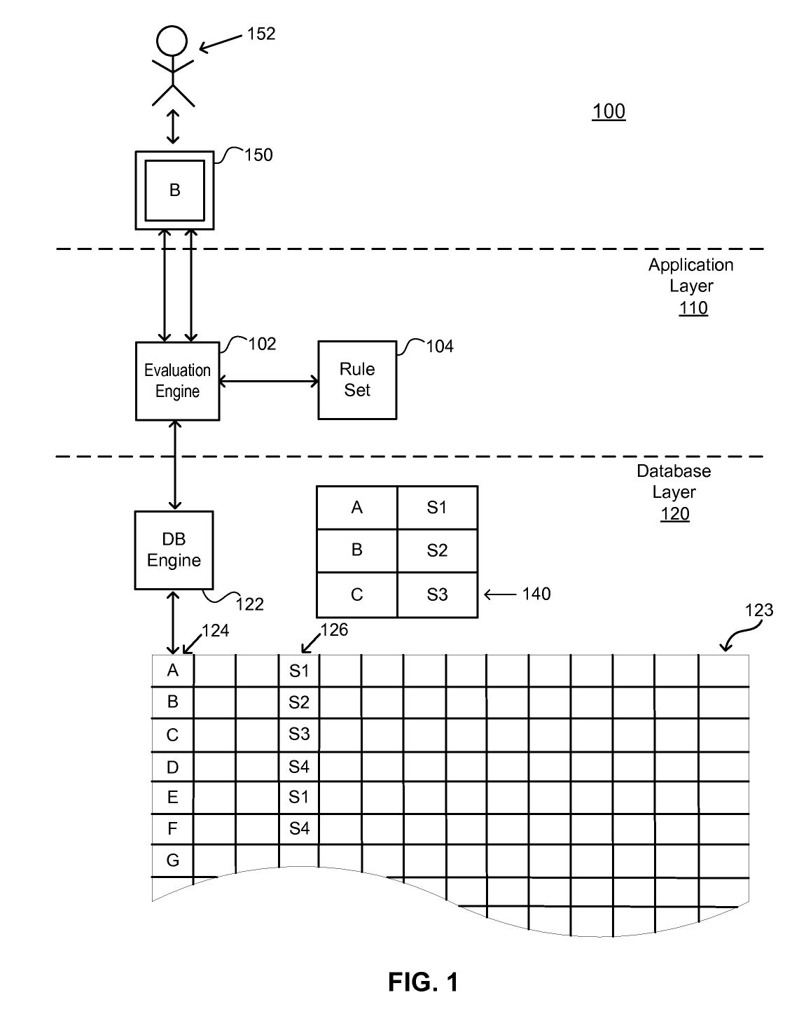

FIG. 1 shows a simplified view a system for data evaluation according to an embodiment. In particular, the system 100 comprises an evaluation engine 102 that is in communication with a precedence rule set 104 according to an embodiment.

The evaluation engine and the precedence rule set, may be located in an application layer 110 that overlies a database layer 120. The evaluation engine may be in communication with a database engine 122 of the database layer, that controls access to database information.

In particular, the database engine may allow the evaluation engine to retrieve from database 123, data records including not only data measurements 124, but also meta-data 126 reflecting the source of those data measurements. The precedence rule set may be structured in such a manner that this source meta-data is considered in rendering a determination of a most relevant data measurement from a plurality of data points.

Thus in the simplified view offered by FIG. 1, the data measurement (B) may be determined to be the most relevant over other competing data measurements (A, C) in a pool 140 selected by the database engine, based upon a reliability/trustworthiness of the source (S2) over the other data sources (S1, S3). Accordingly, the evaluation engine may cause the data measurement B to be displayed on the device 150 of a user 152.

Embodiments may offer benefits over conventional approaches. For example, data averaging (and variants such as removing outliers before averaging, using medians or modes, and showing distributions) can serve to smooth out variances. However, such conventional approaches treat all data points as equally valid.

Another conventional approach for evaluating data is to use weighted averages. While such weighted averages are fixed formulas, they may yield distorted results when data sets are incomplete or spotty.

By contrast, approaches in accordance with embodiments may offer improved results for at least two reasons. First, conventional weighted or other data averaging schemes, cannot employ conditional algorithms (e.g. “use this data unless this other data is available”). Rather, the rules are applied in order, and not all rules are invoked. Only those rules which are relevant to the available data, are applied.

A second possible benefit is that according to embodiments, such precedence rules can be applied to non-numeric data. Examples of such non-numeric data include subjective evaluations, such as movie reviews or employee performance reviews.

Based upon the application of rules as described in conjunction with the instant approach, only the most “trusted” information may be shown, while all other data may be hidden. Such other data, however, remains available and can be accessed by a user seeking additional information.

An algorithm according to an embodiment may rely upon meta-data concerning the “provenance” of the data in question. Specifically, by allowing the system to recognize which data element is most trusted (because the system knows its source), allows only the most relevant data to be shown. Embodiments may thus facilitate decision-making in what might otherwise be “data overload” situations for users lacking formal training in statistics, and facing large amounts of available data.

By utilizing pre-defined rules of data quality, embodiments may offer a useful alternative to conventional approaches that list an entire set of candidate data, or that use a “crowdsourced-style” of like/dislike method of data valuation.

To better illustrate principles according to certain embodiments, an example is now presented in the context of evaluating player prospects for a professional football team. In particular, data compiled multiple sources regarding football player prospects, are stored and manipulated in a HANA in memory database available from SAP AG of Walldorf, Germany.

### EXAMPLE

Each year about 13,000 college players become eligible to play professional football. In order for professional franchises to determine the prospects in which they are interested, candidate players may be the subject of multiple written evaluations from both internal sources (e.g. scouts and Directors), and also from external sources such as National Football Scouting (NFS) reports.

The written player evaluations may be broken into three major sections: Measures, Attributes, and Text. Examples of categories of Measurements which may appear in a written evaluation, may include but are not limited to: Height, Weight, and Speed. Examples of categories of Attributes which may appear in a written evaluation may include but are not limited to: college position, jersey number, and birth date. Examples of categories of Text which may appear in a written evaluation may include but are not limited to: injury, character and personal, and assessments.

The multiple written evaluations may be prepared from different sources at different times, and may contain overlapping data of Measurements, Attributes, and/or Text for a given player. So for each Measure and Attribute, a player may have many values.

The following provides a listing of possible sources of data for the written player evaluations, together with a corresponding database identifier:

| | ID | |
|---|---|---|
| Source of Written Evaluation | ATTRTYPEID | ATTRID |
| NFS Spring Data | 5 | 14 |
| College Report by Team Scouts (summer) | 5 | 5 |
| College Reports by Area Scouts (summer) | 5 | 30 |
| Director Reports (fall) | 5 | 6 |
| NFS Fall Data (early December) | 5 | 16 |
| Director Overrides (early December) | 5 | 13 |
| All-Star (Jan/Feb) | 5 | 8 |
| NFL Combine data | 5 | 23 |
| Team Combine data, | 5 | 22 |
| APT Pro Day (April) | 5 | 11 |
| Team Pro Day | 5 | 9 |

Rather than considering each Measure from each of the different sources, a user may instead seek to identify one current value for a Measure, based on rules defined by the user. Accordingly, embodiments allow a user to determine of a most relevant Measure from amongst competing data points.

Specifically, in this example the Measures have precedence. The precedence is defined by the customer, and can vary by Measure.

Here, the Measure categories of height, weight, and speed, are relevant to decision-making by position. An example rule set for height is as follows:

### Height

1. Director's Override height;
2. NFL Combine verified height;
3. Tallest of: verified team player pro day height, verified APT pro day height, or verified All-star game height;
4. Tallest verified height from NFS spring or NFS fall Databases;
5. Tallest Estimate.

A configurable way in which to implement these preference rules, was created as follows. The Measures and Attributes are persisted in rows of a database. Specifically, each Measure and Attribute has a respective attribute-type identifier (ATTRTYPEID) and an attribute identifier (ATTRID). For Measures, the ATTRTYPEID=13, and the ATTRID's for height, weight, and speed are 31, 32, 33 respectively.

For each of the various sources of data (written evaluations), a report in HANA is created. So, there are report types for each source.

A database table RTCONFIG, defines a context in which Measures, Attributes, and Text can be assigned to the Context. The following shows creation of a Context (99/1)—a logical grouping of data for which the measures of height, weight, and speed respectively, are to be retrieved:

99,1,13,31;

99,1,13,32;

99,1,13,33.

A database table PRECEDENCE, allows assignment of a priority (SORTORDER) to the height data by Report Type:

5,14,13,31,9000 (height of prospect from NFS Spring Data);

5,16,13,31,8000 (height of prospect from NFS Fall Data);

5,6,13,31,7000 (height of prospect from Director Reports);

5,5,13,31,6000 (height of prospect from College Report by Team Scouts);

5,30,13,31,5000 (height of prospect from College Report by Area Scouts)

5,11,13,31,4000 (height of prospect from APT Pro Day);

5,9,13,31,4000 (height of prospect from Team Pro Day)

5,8,13,31,4000 (height of prospect from All-Star)

5,23,13,31,3000 (height of prospect from Team Combine data)

5,22,13,31,3000 (height of prospect from NFL Combine data)

5,13,13,31,100 (height of prospect from Director Overrides).

The final number in each of the above sequences, indicates a precedence value, with the lower the precedence value indicating the higher the priority. Thus here, the height from the Director Overrides has the lowest precedence value (100) and the highest priority, and hence (if available) that is the height measurement which would be provided to a user.

This example indicates that it is possible for height measurements from certain sources to have exactly the same precedence value (e.g. 3000, 4000). In a case where the precedence value is shared by more than one measurement, the precedence rule set may dictate alternate criteria for indicating relevance.

An example of such a rule may be to designate as most relevant, the specific measurement having the highest value (e.g. Max height) of those sharing a common precedence value. Another example may be to designate as most relevant, the most recent measurement of those sharing the same precedence value.

HANA calculation views may be used to derive the current value based on the rules. In an example, for the Measure “height”, it works as required:
1. obtain all the Measures related to a 99/1 (e.g. just height);
2. obtain the report type for the Measure;
3. obtain the precedence for the report type and Measure combinations;
4. obtain the Max value for the MIN SORTORDER; and
5. further reduce if there are multiple values for the same SORTORDER and MIN value (e.g. by date).

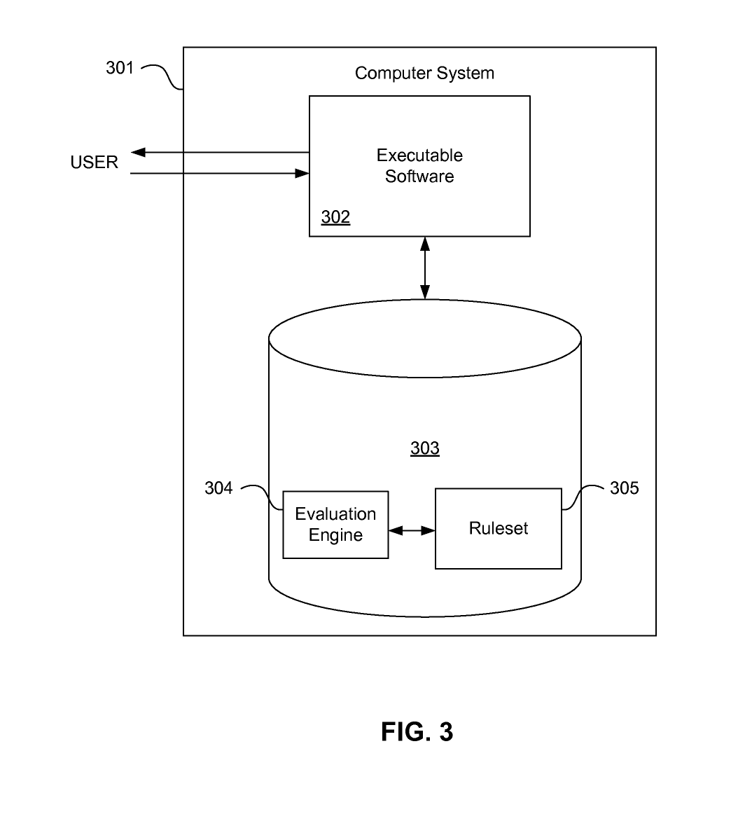

FIG. 3 illustrates hardware of a special purpose computing machine configured to determine a most relevant data measurement according to an embodiment. In particular, computer system 300 comprises a processor 302 that is in electronic communication with a non-transitory computer-readable storage medium 303. This computer-readable storage medium has stored thereon code 305 corresponding to an evaluation engine. Code 504 corresponds to a precedence rule set. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

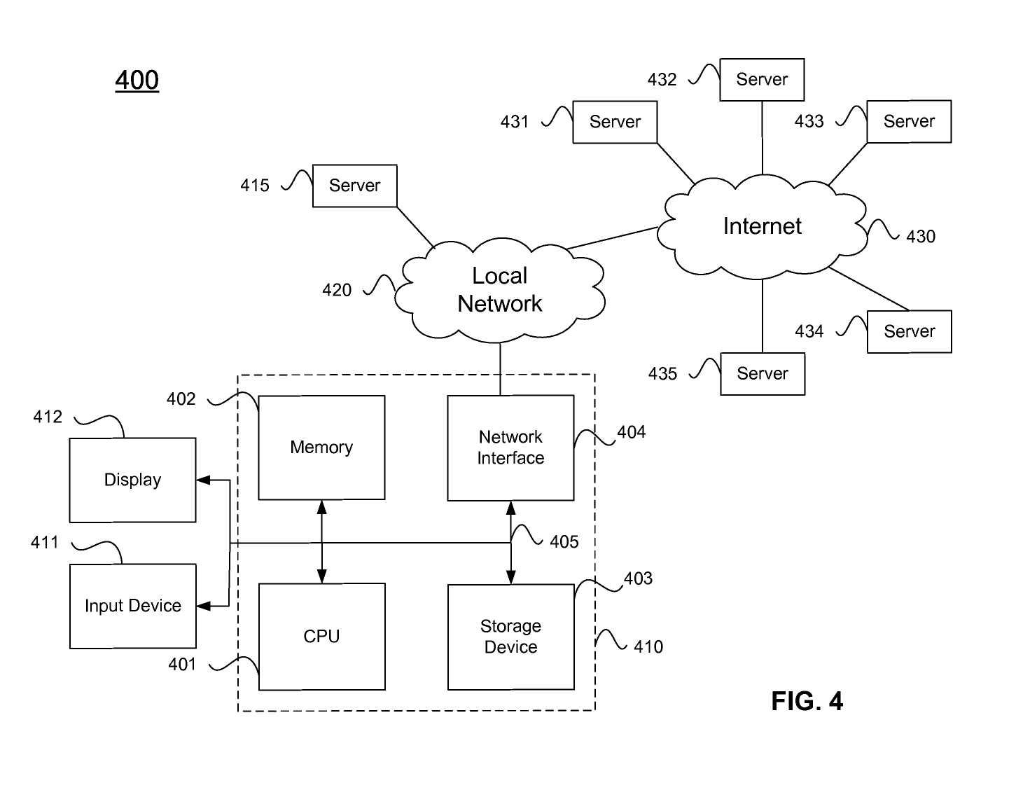

An example computer system 410 is illustrated in FIG. 4. Computer system 410 includes a bus 405 or other communication mechanism for communicating information, and a processor 401 coupled with bus 405 for processing information. Computer system 410 also includes a memory 402 coupled to bus 405 for storing information and instructions to be executed by processor 401, including information and instructions for performing the techniques described above, for example. This memory may also be used for storing variables or other intermediate information during execution of instructions to be executed by processor 401. Possible implementations of this memory may be, but are not limited to, random access memory (RAM), read only memory (ROM), or both. A storage device 403 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 403 may include source code, binary code, or software files for performing the techniques above, for example. Storage device and memory are both examples of computer readable mediums.

Computer system 410 may be coupled via bus 405 to a display 412, such as a cathode ray tube (CRT) or liquid crystal display (LCD), for displaying information to a computer user. An input device 411 such as a keyboard and/or mouse is coupled to bus 405 for communicating information and command selections from the user to processor 401. The combination of these components allows the user to communicate with the system. In some systems, bus 405 may be divided into multiple specialized buses.

Computer system 410 also includes a network interface 404 coupled with bus 405. Network interface 404 may provide two-way data communication between computer system 410 and the local network 420. The network interface 404 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 404 sends and receives electrical, electromagnetic, or optical signals that carry digital data streams representing various types of information.

Computer system 410 can send and receive information, including messages or other interface actions, through the network interface 404 across a local network 420, an Intranet, or the Internet 430. For a local network, computer system 410 may communicate with a plurality of other computer machines, such as server 415. Accordingly, computer system 410 and server computer systems represented by server 415 may form a cloud computing network, which may be programmed with processes described herein. In the Internet example, software components or services may reside on multiple different computer systems 410 or servers 431-435 across the network. The processes described above may be implemented on one or more servers, for example. A server 431 may transmit actions or messages from one component, through Internet 430, local network 420, and network interface 404 to a component on computer system 410. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
providing an evaluation engine in communication with a database comprising a first data measurement, a first meta-data indicating a first source of the first data measurement, a second data measurement, and a second meta-data indicating a second source of the second data measurement;
causing the evaluation engine to calculate from the first meta-data, a first precedence value for the first data measurement;
causing the evaluation engine to calculate from the second meta-data, a second precedence value for the second data measurement; and
causing the evaluation engine to reference a precedence rule set to determine a relevance of the first data measurement over the second data measurement.

2. A method as in claim 1 wherein:
the first precedence value is different from the second precedence value; and
the first precedence value indicates a provenance of the first source is greater than a provenance of the second source.

3. A method as in claim 1 wherein:
the first precedence value is the same as the second precedence value; and
the precedence rule set relies upon a secondary criterion to determine the relevance of the first data measurement over the second data measurement.

4. A method as in claim 3 wherein the secondary criterion comprises a relative magnitude of the first data measurement versus the second data measurement.

5. A method as in claim 3 wherein the secondary criterion comprises a freshness of the first data measurement versus the second data measurement.

6. A method as in claim 1 further comprising causing the evaluation engine to display the first data measurement to a user.

7. A non-transitory computer readable storage medium embodying a computer program for performing a method, said method comprising:
providing an evaluation engine in communication with a database comprising a first data measurement, a first meta-data indicating a first source of the first data measurement, a second data measurement, and a second meta-data indicating a second source of the second data measurement;
causing the evaluation engine to calculate from the first meta-data, a first precedence value for the first data measurement;
causing the evaluation engine to calculate from the second met-data, a second precedence value for the second data measurement; and
causing the evaluation engine to reference a precedence rule set to determine a relevance of the first data measurement over the second data measurement.

8. A non-transitory computer readable storage medium as in claim 7 wherein:
the first precedence value is different from the second precedence value; and
the first precedence value indicates a provenance of the first source is greater than a provenance of the second source.

9. A non-transitory computer readable storage medium as in claim 7 wherein:
the first precedence value is the same as the second precedence value; and
the precedence rule set relies upon a secondary criterion to determine the relevance of the first data measurement over the second data measurement.

10. A non-transitory computer readable storage medium as in claim 9 wherein the secondary criterion comprises a relative magnitude of the first data measurement versus the second data measurement.

11. A non-transitory computer readable storage medium as in claim 9 wherein the secondary criterion comprises a freshness of the first data measurement versus the second data measurement.

12. A non-transitory computer readable storage medium as in claim 7 wherein the method further comprises causing the evaluation engine to display the first data measurement to a user.

13. A computer system comprising:
one or more processors;
a software program, executable on said computer system, the software program configured to:
provide an evaluation engine in communication with a database comprising a first data measurement, a first meta-data indicating a first source of the first data measurement, a second data measurement, and a second meta-data indicating a second source of the second data measurement;
cause the evaluation engine to calculate from the first meta-data, a first precedence value for the first data measurement;
cause the evaluation engine to calculate from the second meta-data, a second precedence value for the second data measurement; and
cause the evaluation engine to reference a precedence rule set to determine a relevance of the first data measurement over the second data measurement.

14. A computer system as in claim 13 wherein:
the first precedence value is different from the second precedence value; and
the first precedence value indicates a provenance of the first source is greater than a provenance of the second source.

15. A computer system as in claim 13 wherein:
the first precedence value is the same as the second precedence value; and
the precedence rule set relies upon a secondary criterion to determine the relevance of the first data measurement over the second data measurement

16. A computer system as in claim 15 wherein the secondary criterion comprises a relative magnitude of the first data measurement versus the second data measurement.

17. A computer system as in claim 15 wherein the secondary criterion comprises a freshness of the first data measurement versus the second data measurement.

18. A computer system as in claim 13 wherein the software program is further configured to causing the evaluation engine to display the first data measurement to a user.
